(19) United States
(12) Patent Application Publication
(10) Pub. No.: US 2025/0019213 A1
(43) Pub. Date: Jan. 16, 2025

(54) FOOT OPERATED LIFTING AIRBAG DEVICE

(71) Applicant: Baiyi Gao, Qingdao (CN)

(72) Inventor: Baiyi Gao, Qingdao (CN)

(21) Appl. No.: 18/900,876

(22) Filed: Sep. 29, 2024

(30) Foreign Application Priority Data
Jul. 11, 2024 (CN) 202410926654.0

(51) Int. Cl. B66F 3/42; B66F 3/35

(52) U.S. Cl. CPC B66F 3/42; B66F 3/35

(57) ABSTRACT

The present invention provides a foot type lifting airbag device, which relates to the field of lifting airbag equipment. The foot type lifting airbag device comprises a support base plate, and the top of the support base plate is fixedly provided with a foot pedal device body. The interior of the foot pedal device body is provided with two piston guide cylinders, and the top of both piston guide cylinders is equipped with a piston pressure pedal. The bottom of both piston guide cylinders is provided with a pressure channel, and the bottom of both pressure channels is provided with a piston gas channel inlet.

### TECHNICAL FIELD

The present invention relates to the field of lifting airbag equipment, specifically a foot operated lifting airbag device.

### BACKGROUND TECHNOLOGY

Nowadays, airbags are used in industry and households for leveling and moving objects. Their structure consists of an elastic hand-held ball connected to the airbag through a tube. When the hand holds or presses the hand-held ball, it compresses the ball, causing it to deform. Then, the gas in the hand-held ball is pushed into the airbag bag, causing the airbag bag to inflate. When the airbag is placed between two objects, it will do work on the two objects due to the inflation of the airbag, achieving the function of lifting or pushing. The disadvantage of its structure is that it relies entirely on the grip force of the hand or fingers, which is very small, similar to holding an egg and cannot be crushed. It does not require force, and the lifting force output by the airbag is about 4 times the grip force of the hand. Lifting an object weighing 10 kilograms with the fingers is already very heavy. An adult can inflate the ball by pinching it with their hand, with a limit of about 40 kilograms. If something weighing more than 70 kilograms is pressed on it, the hand can hardly move it. At the same time, pinching the ball with their hand is elastic, and when the pressure is high, the ball will deform, releasing the grip force of the hand. If the ratio of pinching the ball with their hand to the airbag is changed, it will take longer to inflate, which is also unbearable for humans. Therefore, the current The structure cannot lift heavier objects, and the one-way valve on the ball is made of rubber cut, which is prone to air leakage when there is dust in the air, Easy to detach when encountering unexpected high-pressure reaction forces. Therefore, the present invention proposes a foot type lifting airbag device, which effectively solves the above-mentioned problems and challenges.

### SUMMARY OF THE INVENTION

### Technical Problems Solved

In response to the shortcomings of existing technology, the present invention provides a foot type lifting airbag device. Compared with traditional hand pinch lifting airbags, the inflation speed of the airbag is slower, and the output air pressure makes the lifting force generated by the airbag lower. The airbag cannot lift and push heavier objects. The foot type lifting airbag device mainly solves the problem of labor-saving and can easily output higher air pressure. For airbags of the same size, stepping on them and applying pressure is based on the weight of the human body. A man's weight is calculated as 50 kilograms, and stepping on an air pump to pinch the ball with both hands can output a lifting force of 100 kilograms solely based on weight. If you step on it with more force, you can lift it. A heavier object that rises up is equivalent to 2 to 3 times the pressure output of a hand-held ball. And it's very easy. The foot operated lifting airbag converts weight into pressure, and the pressure generated by weight is many times that of manual force, so there is a lot of space to adjust the size of the piston of the foot operated inflation pump. The inflation speed is faster than manual inflation, and the pressure generated is also much higher than manual inflation.

### Technical Solution

To achieve the above objectives, the present invention is implemented through the following technical solutions: a foot supported lifting airbag device, comprising a support base plate, wherein the top of the support base plate is fixedly provided with a foot pedal device body, and both sides of the top of the foot pedal device body are provided with air inlets. The interior of the foot pedal device body is provided with two piston guide cylinders, and the top of both piston guide cylinders is equipped with piston pressure pedals. The bottom of the two air inlet channels are connected with piston gas channel inlets, and the two piston gas channel inlets are connected with a main gas channel located inside the support base plate, The main gas channel is equipped with a pressing valve body at one end away from the inlet of the two piston gas channels. One end of the pressing valve body is connected to the main gas channel, and the end of the pressing valve body away from the main gas channel is connected to a gas tube. The end of the gas tube away from the pressing valve body is fixedly equipped with a lifting airbag.

Preferably, both piston gas channel inlets are equipped with reset springs at the top.

Preferably, piston sealing rings are installed at the junction of the bottom of both intake channels and the return spring.

Preferably, both of the reset springs are located at the top of the piston sealing ring and have an upper wall of the piston sealing ring. Both of the reset springs are located at the bottom of the piston sealing ring and have a lower wall of the piston sealing ring.

Preferably, both ends of the lower walls of the two piston sealing rings are provided with gaps in the lower walls of the sealing rings.

Preferably, a pressure output one-way valve ball is provided inside the pressing valve body, and a valve ball inlet is fixedly provided at the connection between the pressure output one-way valve ball and the main gas channel.

Preferably, the compression valve body is located away from the main gas channel and connected to the trachea by the pressure output one-way valve ball, and a compression valve nozzle is provided at the connection between the pressure output one-way valve ball and the trachea.

Preferably, the top of the pressing valve body has a release button, and the bottom of the release button is equipped with a pressing sealing spring. The release button releases air by pressing the sealing spring, and a pressing valve sealing gasket is installed between the pressing valve body and the release button.

Working principle: The foot type lifting airbag device is connected to the airbag through a gas tube and a pressure valve nozzle. The pressure sealing spring pushes up the release button to seal the pressure sealing gasket and seal the pressure valve body. The one-way valve ball for air pressure output seals the air inlet of the ball valve under the action of gravity, forming a closed space between the airbag, gas tube, and pressure valve body. When working, stepping on the piston pressure pedal to apply pressure, the body weight of the human body will be converted into pressure, which will be applied to the piston pressure pedal. The piston pressure pedal will transmit the force downwards through the piston guide cylinder, driving the piston to move downwards, compressing and pushing the piston reset spring to store kinetic energy. The gap between the upper arm of the piston seal ring and the lower wall of the piston seal ring is greater than the diameter of the lower piston seal ring. The piston is pressed downwards, and the upper arm of the, The piston sealing ring and the piston outer wall are in a sealed relationship. Under the action of friction, they wait in place. The upper arm of the piston sealing ring will tightly adhere to the piston sealing ring, and the piston sealing ring will tightly adhere to the piston outer wall, forming a closed space at the lower end of the piston. With further foot pressure, the compressed air will enter the gas channel through the piston gas channel inlet and reach the pressure output one-way valve ball. Under the action of air pressure, the pressure output one-way valve ball is pushed upward, and the compressed air will leave the ball valve inlet. The compressed air will enter the pressing valve body and then enter the airbag through the air pipe. When the gas enters, the airbag will expand in volume. When the pressure pedal of the piston is stepped on, it will push the piston stroke to the end, and the gas will stop compressing. The sentence is: The pressure output one-way valve ball moves downward under the action of gravity, sealing the inlet of the ball valve, forming a closed space for the airbag, trachea, and pressing the valve body again. The incoming gas will not be discharged. When the foot is lifted, the piston pressure pedal loses the pressure of the foot, and the kinetic energy stored in the spring that pushes the piston to reset is released. Under the action of pushing the piston reset spring, the piston and the upper wall of the piston sealing ring move upward, and the piston sealing ring stays in place under the frictional force with the outer wall of the piston. After the lower wall of the piston sealing ring contacts the piston sealing ring, it will drive the piston sealing ring to move upward together. At this time, the fitting state between the piston sealing ring and the upper arm of the piston sealing ring is opened, forming a gap. There is a gap between the upper arm of the piston seal ring and the outer wall of the piston. Due to the one-way valve ball blocking the ball valve inlet, the piston moves upward, creating negative pressure in the space between the piston and the bottom of the piston. The negative pressure air in the air channel will pass through the gap between the upper arm of the piston seal ring and the outer wall of the piston, reaching the position of the piston seal ring. The inner diameter of the piston seal ring is larger than the diameter of the piston at the installation position, and there is a gap in the middle. Air passes through the gap between the piston seal ring and the upper arm of the piston seal ring, then continues to descend through the gap between the piston seal ring and the piston installation position, and then enters the cavity at the lower end of the piston formed by the upward movement of the piston through the gap on the lower wall of the piston seal ring. At this time, the air between the piston guide cylinder and the piston outer wall is sucked into the bottom of the piston, forming negative pressure, and there is a gap between the piston guide cylinder and the piston outer wall guide port. Air will enter the cavity between the piston guide cylinder and the piston outer wall through the aperture between the piston guide cylinder and the piston outer wall guide port. When the piston moves up to its peak, it stops moving. At this time, the air pressure at the lower end of the piston is the same as the external pressure, filled with air. When the piston pressure pedal is stepped on again with the foot, the above action will be repeated. The airbag continues to have new air added, the air pressure rises, and the volume expands. When the airbag is placed between two objects, it will generate the same thrust on the two objects. This force can lift or push the objects. When the work is completed or the airbag height needs to be adjusted, press the deflation button, the deflation button will descend, and the valve sealing gasket will follow down. There will be a gap between the valve sealing gasket and the valve body. There is a gap between the deflation button and the valve body. At this time, the high-pressure gas in the airbag will pass through the trachea, and then press it again. The valve nozzle enters the pressing valve body, Then, by pressing the gap between the valve gasket and the valve body, as well as the gap between the release button and the valve body, the gas in the airbag is released. When the release button is stopped, the gas in the airbag is released. Since the release button is pressed against the release button by the spring in the valve body, the release button and the press valve body squeeze the valve gasket. The one-way valve ball of the pressure output blocks the inlet of the ball valve under the action of gravity, so there will be no gas leakage regardless of high or low pressure.

### Beneficial Effects

The present invention provides a foot operated lifting airbag device. Has the following beneficial effects:

The present invention provides a foot operated lifting airbag device, which has the disadvantage of slower inflation speed and lower lifting force generated by the airbag due to the output air pressure compared to traditional hand held lifting airbags. The airbag cannot lift and push heavier objects. The foot operated lifting airbag device mainly solves the problem of labor-saving and can easily output higher air pressure. For airbags of the same size, stepping on them and applying pressure is based on the weight of the human body. A man's weight is calculated as 50 kilograms, and the foot operated punching cylinder is the size of a two handed ball, so it can output 100 kilograms of lifting force solely based on weight. If you step on it with more force, you can lift heavier objects. Equivalent to a pressure value of 2 to 3 times the output of a hand held ball. And it's very easy. The foot operated lifting airbag converts weight into pressure, and the pressure generated by weight is many times that of manual force, so there is a lot of space to adjust the size of the piston of the foot operated inflation pump. The inflation speed is faster than manual inflation, and the pressure generated is also much higher than manual inflation.

### ATTACHED IMAGE DESCRIPTION

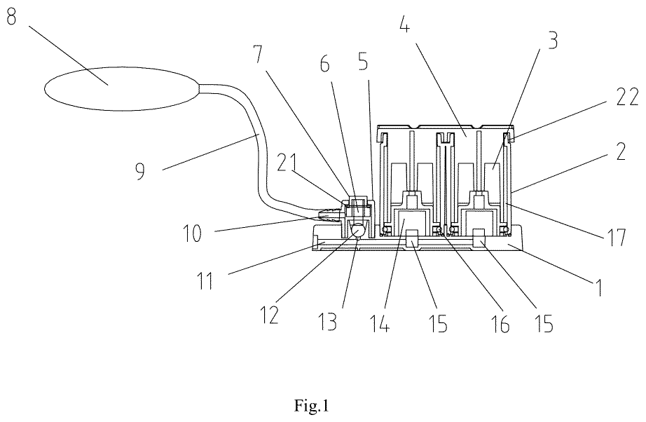

FIG. 1 is a front view of a foot operated lifting airbag device of the present invention;

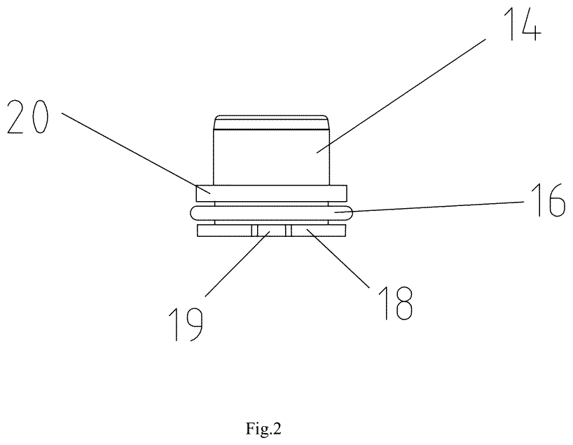

FIG. 2 is a schematic diagram of the sealing piston ring structure of a foot type lifting airbag device of the present invention;

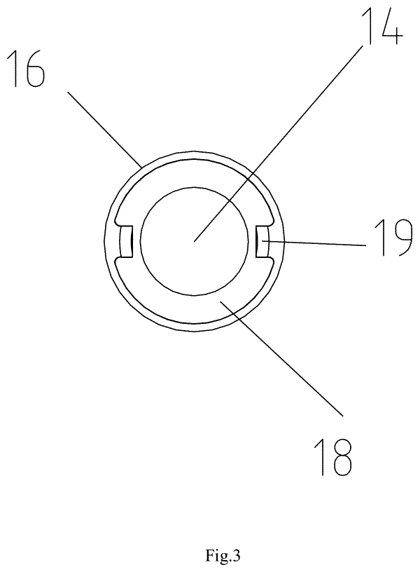

FIG. 3 is a bottom view of the sealing piston ring of a foot operated lifting airbag device according to the present invention.

Among them, 1. Support the bottom plate; 2. Pedal equipment body; 3. Piston guided cylinder; 4. Piston pressure pedal; 5. Press the valve body; 6. Press the sealing spring; 7. Air release button; 8. Lift the airbag; 9. Tracheal tract; 10. Press the valve nozzle; 11. Main gas channel; 12. Pressure output one-way valve ball; 13. Valve ball inlet; 14. Reset spring; 15. Piston gas channel inlet; 16. Piston sealing ring; 17. Intake passage; 18. Lower wall of piston sealing ring; 19. Gap on the lower wall of the sealing ring; 20. Upper wall of piston sealing ring; 21. Press the valve gasket; 22. Air inlet.

### Specific Implementation Method

Below, the technical solutions in the embodiments of the present invention will be clearly and completely described in conjunction with the accompanying drawings. Obviously, the described embodiments are only a part of the embodiments of the present invention, not all of them. Based on the embodiments of the present invention, all other embodiments obtained by ordinary skilled persons in the art without creative labor are within the scope of protection of the present invention. In the description of the present application, it should be noted that the terms used here are only for the purpose of describing specific embodiments, and are not intended to limit the exemplary embodiments according to the present application. For ease of description, the dimensions of the various parts shown in the attached figure are not drawn according to the actual proportional relationship. For technologies, methods, and equipment known to ordinary technical personnel in related fields, detailed discussions may not be made, but in appropriate circumstances, such technologies, methods, and equipment should be considered as part of the authorization manual. In all the examples shown and discussed here, any specific value should be interpreted as merely illustrative and not restrictive. Therefore, other examples of exemplary embodiments may have different values. It should be noted that similar labels and letters represent similar items in the following figures. Therefore, once an item is defined in one figure, it does not need to be further discussed in subsequent figures.

### Example 1

As shown in FIGS. 1-3, an embodiment of the present invention provides a foot type lifting airbag device, which comprises: Airbag, trachea, deflation button, sealing gasket, gas channel, one-way valve ball for air pressure output, compression sealing spring, piston pressure pedal, push piston reset spring, piston sealing ring, gap in the lower wall of the piston sealing ring, lower wall of the piston sealing ring, upper wall of the piston sealing ring, outer wall of the piston, and support base plate. Support base plate 1 has a foot pedal device main body 2 fixed at the top of support base plate 1, and both sides of the top of foot pedal device main body 2 have air inlet 22. The interior of foot pedal device main body 2 is located at the extension of air inlet 22 and has air inlet channel 17. There are two piston guide cylinders 3 inside foot pedal device main body 2, and piston pressure pedals 4 are installed at the top of both piston guide cylinders 3. Two air inlet channels 17 are also provided. The bottom is connected to a piston gas channel inlet 15, Two piston gas channel inlets 15 are connected to a main gas channel 11, which is located inside the supporting base plate 1. One end of the main gas channel 11 away from the two piston gas channel inlets 15 is provided with a pressing valve body 5, which is connected to the main gas channel 11 at one end. The end of the pressing valve body 5 away from the main gas channel 11 is connected to a gas tube 9, and the end of the gas tube 9 away from the pressing valve body 5 is fixedly provided with a lifting airbag 8.

The top of the two piston gas channel inlets 15 are equipped with reset springs 14, and the bottom of the two intake channels 17 is equipped with piston sealing rings 16 at the junction of the reset springs 14. The two reset springs 14 are located at the top of the piston sealing rings 16 and are equipped with piston sealing ring upper walls 20. The two reset springs 14 are located at the bottom of the piston sealing rings 16 and are equipped with piston sealing ring lower walls 18. Both ends of the lower walls 18 of the two piston sealing rings are provided with sealing ring lower wall notches 19. A pressure output one-way valve ball 12 is set inside the pressing valve body 5, and a valve ball inlet 13 is fixedly set at the connection between the pressure output one-way valve ball 12 and the main gas channel 11. The pressure output one-way valve ball 12 is located far away from the pressure output one-way valve ball 12 inside the pressing valve body 5. The main gas channel 11 is connected to the trachea 9, and a pressure output one-way valve ball 12 is equipped with a pressure valve nozzle 10 at the connection with the trachea 9, There is a release button 7 on the top of valve body 5, and a sealing spring 6 is installed at the bottom of the release button 7. The release button 7 releases air by pressing the sealing spring 6. A sealing gasket 21 is installed between valve body 5 and release button 7.

The complete usage process of the foot lift airbag is as follows:

S1: The airbag of the device is connected to the gas tube and the pressure valve nozzle. The pressure sealing spring pushes up the release button to seal the pressure sealing gasket and seal the pressure valve body. The one-way valve ball for air pressure output seals the inlet of the ball valve under the action of gravity, forming a closed space between the airbag, gas tube, and pressure valve body. When working, stepping on the piston pressure pedal to apply pressure, the body weight of the human body will be converted into pressure, which will be applied to the piston pressure pedal. The piston pressure pedal will transmit the force downwards through the piston guide cylinder, driving the piston down and compressing the piston reset spring to store kinetic energy. The gap between the upper wall of the piston seal ring and the lower wall of the piston seal ring is greater than the diameter of the lower piston seal ring. The piston is pressed down, and the upper arm of the piston seal ring follows down. The piston seal ring and the Sealing relationship, under the action of friction, Waiting in place, the upper arm of the piston seal ring will tightly adhere to the piston seal ring, and the piston seal ring will tightly adhere to the outer wall of the piston, forming a closed space at the lower end of the piston. With further foot pressure, the air will be compressed and enter the gas channel through the piston gas channel inlet, reaching the pressure output check valve ball. Under the action of air pressure, the pressure output check valve ball is pushed upward, leaving the ball valve inlet. The compressed air enters the pressing valve body and then enters the airbag through the trachea. When the gas enters, the airbag expands in volume. When the piston pressure pedal is stepped on to push the piston stroke to the end, the gas stops compressing, and the pressure output check valve ball moves downward under the action of gravity, sealing the ball valve inlet. Airbag, trachea, Pressing the valve body creates a closed space again, and the incoming gas will not be expelled.

S2: When the foot is lifted, the piston pressure pedal loses the pressure of the foot, and the kinetic energy stored in the spring that pushes the piston to reset is released. Under the action of the piston reset spring, the piston and the upper wall of the piston seal ring move upward. The piston seal ring stays in place under the frictional force with the outer wall of the piston. After the lower wall of the piston seal ring contacts the piston seal ring, it will drive the piston seal ring to move upward together. At this time, the fitting state between the piston seal ring and the upper arm of the piston seal ring is opened, forming a gap. There is a gap between the upper arm of the piston seal ring and the outer wall of the piston. Due to the one-way valve ball blocking the ball valve inlet, the piston moves upward, creating negative pressure in the space between the piston and the bottom of the piston. The negative pressure air in the air channel will pass through the gap between the upper arm of the piston seal ring and the outer wall of the piston, reaching the position of the piston seal ring. The inner diameter of the piston seal ring is larger than the diameter of the piston at the installation position, and there is a gap in the middle. Air passes through the gap between the piston seal ring and the upper arm of the piston seal ring, then continues to descend through the gap between the piston seal ring and the piston installation position, and then enters the cavity at the lower end of the piston formed by the upward movement of the piston through the gap on the lower wall of the piston seal ring. At this time, the air between the piston guide cylinder and the piston outer wall is sucked into the bottom of the piston, forming negative pressure, and there is a gap between the piston guide cylinder and the piston outer wall guide port. Air will enter the cavity between the piston guide cylinder and the piston outer wall through the aperture between the piston guide cylinder and the piston outer wall guide port. When the piston moves upward to its peak, it stops moving, and the lower end of the piston is filled with air at the same pressure as the outside.

S3: When stepping on the piston pressure pedal again with your foot, repeat the above actions. New air is continuously added to the airbag, causing the air pressure to rise and the volume to expand. When the airbag is placed between two objects, it will generate the same thrust on both objects, which can lift or push the objects. When the work is completed or the airbag height needs to be adjusted, press the deflation button, the deflation button will descend, and the valve sealing gasket will follow down. There will be a gap between the deflation button and the valve body. At this time, the high-pressure gas in the airbag will pass through the trachea, enter the valve body through the valve nozzle, and then pass through the gap between the valve sealing gasket and the valve body. The gap between the release button and the pressed valve body is discharged, When the release button is stopped, the discharge of gas from the airbag is stopped. As the spring in the valve body presses against the release button, the release button and the valve body compress the valve gasket. The one-way valve ball for air pressure output blocks the inlet of the ball valve under the action of gravity, so there will be no gas leakage regardless of high or low pressure.

Although the embodiments of the present invention have been shown and described, it will be understood by those skilled in the art that various changes, modifications, substitutions, and variations can be made to these embodiments without departing from the principles and spirit of the present invention. The scope of the present invention is limited by the appended claims and their equivalents.

What is claimed is:

1. A foot operated lifting airbag device, comprising a support base plate (1), characterized in that: the top of the support base plate (1) is fixedly provided with a foot operated equipment body (2), and the top of both sides of the foot operated equipment body (2) are provided with air inlet ports (22). The interior of the foot operated equipment body (2) is provided with air inlet channels (17) located at the extension of the air inlet ports (22). The interior of the foot operated equipment body (2) is provided with two piston guide cylinders (3), and the top of the two piston guide cylinders (3) is equipped with piston pressure pedals (4). The bottom of the two air inlet channels (17) are connected with piston gas channel inlets (15). The two piston gas channel inlets (15) are connected to a main gas channel (11) located inside the support base plate (1), The main gas channel (11) is equipped with a pressing valve body (5) at one end away from the two piston gas channel inlets (15), and one end of the pressing valve body (5) is connected to the main gas channel (11). The end of the pressing valve body (5) away from the main gas channel (11) is connected to a gas pipe (9), and the end of the gas pipe (9) away from the pressing valve body (5) is fixedly equipped with a lifting airbag (8).

2. A foot operated lifting airbag device according to claim 1, characterized in that the top of both piston gas channel inlets (15) are equipped with return springs (14).

3. A foot operated lifting airbag device according to claim 1, characterized in that piston sealing rings (16) are installed at the junction of the bottom of the two intake channels (17) and the return spring (14).

4. A foot operated lifting airbag device according to claim 2, characterized in that: two reset springs (14) are located at the top of the piston sealing ring (16) and both are provided with piston sealing ring upper walls (20), and two reset springs (14) are located at the bottom of the piston sealing ring (16) and both are provided with piston sealing ring lower walls (18).

5. A foot operated lifting airbag device according to claim 4, characterized in that both ends of the lower walls (18) of the two piston sealing rings are provided with sealing ring lower wall notches (19).

6. A foot operated lifting airbag device according to claim 1, characterized in that: a pressure output one-way valve ball (12) is provided inside the pressing valve body (5), and a valve ball inlet (13) is fixedly provided at the connection between the pressure output one-way valve ball (12) and the main gas channel (11).

7. A foot operated lifting airbag device according to claim 1, characterized in that: the pressure output one-way valve ball (12) located inside the pressing valve body (5) is far away from the main gas channel (11) and connected to the trachea (9), and a pressing valve nozzle (10) is provided at the connection between the pressure output one-way valve ball (12) and the trachea (9).

8. A foot operated lifting airbag device according to claim 1, characterized in that: the top of the pressing valve body (5) has a release button (7), the bottom of the release button (7) is equipped with a pressing sealing spring (6), the release button (7) releases air by pressing the sealing spring (6), and a pressing valve sealing gasket (21) is installed between the pressing valve body (5) and the release button (7).
